(19) United States
(12) Patent Application Publication
(10) Pub. No.: US 2024/0124037 A1
(43) Pub. Date: Apr. 18, 2024

(54) AUTHENTICATION SYSTEM, AUTHENTICATION DEVICE, AND AUTHENTICATION METHOD

(71) Applicant: Mitsubishi Electric Corporation, Chiyoda-ku, Tokyo (JP)

(72) Inventor: Daisuke KOSHINO, Tokyo (JP)

(73) Assignee: Mitsubishi Electric Corporation, Chiyoda-ku, Tokyo (JP)

(21) Appl. No.: 18/546,471

(22) PCT Filed: Mar. 31, 2021
(86) PCT No.: PCT/JP2021/013845

§ 371 Date: Aug. 15, 2023

(51) Int. Cl. B61L 15/00; G07C 9/00

(52) U.S. Cl. CPC B61L 15/0072; B61L 15/009; G07C 9/00174

(57) ABSTRACT

An authentication system includes: an electronic key that transmits a signal including authority information indicating authority given to an owner and an authentication key; a plurality of on-board stations installed on a train to receive the signal from the electronic key; and an authentication device that determines a position of the electronic key from a reception status of the signal including the same authentication key in the plurality of on-board stations, and determines, on the basis of the position of the electronic key and the authority information, whether to permit departure of the train and whether to permit operation of a control console of the train.

### FIELD

The present disclosure relates to an authentication system, an authentication device, and an authentication method for use in an automatically operable train.

### BACKGROUND

Conventional systems permit a user to use an automobile, for example, by providing an integrated circuit (IC) card with authority information such as license information possessed by the user and authenticating the authority information of the IC card. For example, Patent Literature 1 discloses a technique for a vehicle operation system that provides an IC card with information on a region category and permits use of a business vehicle in a region indicated by the region category. The vehicle operation system of Patent Literature 1 is designed such that a user having driving authority in a certain region is allowed to move a business vehicle in that region, whereas a user having no driving authority in a certain region is not allowed to move a business vehicle in the region.

### CITATION LIST

### Patent Literature

Patent Literature 1: Japanese Patent Application Laid-open No. 2014-227647

### SUMMARY OF INVENTION

### Problem to be Solved by the Invention

In recent years, automatic operation and driverless operation of trains have progressed. Automatically operable trains are not necessarily manned by a driver who has a train operation license, but may be manned only by a crew member who does not have a train operation license. In the case of a conventional train operated by a driver, the driver of the train has a key to the control console and has its key attached to the driver's belt, thereby preventing the driver from leaving the train with the key in the control console, and avoiding a situation in which the train moves without the driver. In the case of a driverless train, the train needs to run with no driver on board but a crew member alone on board, and there is a possibility that the train may depart while the crew member is accidentally out of the train.

A possible solution to this problem is to apply the technique described in Patent Literature 1, providing that but it is necessary for the driverless train to change control depending on the authority and position of the person on board. Specifically, the technique described in Patent Literature 1 poses a problem of failure to appropriately permit the departure even though the driverless train is able to depart when the crew member or driver is in a cabin. An attempt to address the above problem can result in another problem: the departure may be permitted when the driver is near the cab but out of the train. In addition, the driverless train needs to be controlled so as to permit operation of the control console when the driver is in the cab and not to permit operation of the control console when the crew member is in the cab.

The present disclosure has been made in view of the above, and an object thereof is to obtain an authentication system capable of controlling departure of an automatically operable train and operation of the train by a person on board.

### Means to Solve the Problem

To solve the above problems and achieve the object, an authentication system according to the present disclosure comprises: an electronic key to transmit a signal including authority information indicating authority given to an owner and an authentication key; a plurality of on-board stations installed on a train to receive the signal from the electronic key; and an authentication device to determine a position of the electronic key from a reception status of the signal including the same authentication key in the plurality of on-board stations, and determine, on a basis of the position of the electronic key and the authority information, whether to permit departure of the train and whether to permit operation of a control console of the train.

### Effects of the Invention

The authentication system according to the present disclosure can achieve the effect of controlling the departure of the automatically operable train and operation of the train by the person on board.

### BRIEF DESCRIPTION OF DRAWINGS

FIG. 1 is a diagram illustrating an exemplary configuration of an authentication system according to a first embodiment.

FIG. 2 is a flowchart illustrating the operation of the authentication system according to the first embodiment.

FIG. 3 is a diagram illustrating an example of a method of determining the position of an electronic key in a position determination unit of an authentication device according to the first embodiment.

FIG. 4 is a diagram illustrating an exemplary configuration of a train in which the authentication system according to the first embodiment is used.

FIG. 5 is a diagram illustrating an example in which the driver is outside the train in the authentication system according to the first embodiment.

FIG. 6 is a diagram illustrating an example in which the driver is in the cab of the train in the authentication system according to the first embodiment.

FIG. 7 is a diagram illustrating an example in which the driver is in the cabin of the train in the authentication system according to the first embodiment.

FIG. 8 is a diagram illustrating an example in which a crew member is in the cab of the train in the authentication system according to the first embodiment.

FIG. 9 is a flowchart illustrating the operation of a determination processing unit of the authentication device according to the first embodiment.

FIG. 10 is a diagram illustrating an exemplary configuration of processing circuitry in the case that the processing circuitry provided in the authentication system according to the first embodiment is implemented by a processor and a memory.

FIG. 11 is a diagram illustrating an exemplary configuration of processing circuitry in the case that the processing circuitry provided in the authentication system according to the first embodiment is implemented by dedicated hardware.

FIG. 12 is a first diagram illustrating an exemplary configuration of an authentication system according to a second embodiment.

FIG. 13 is a second diagram illustrating an exemplary configuration of an authentication system according to the second embodiment.

### DESCRIPTION OF EMBODIMENTS

An authentication system, an authentication device, and an authentication method according to embodiments of the present disclosure will be hereinafter described in detail with reference to the drawings.

### First Embodiment

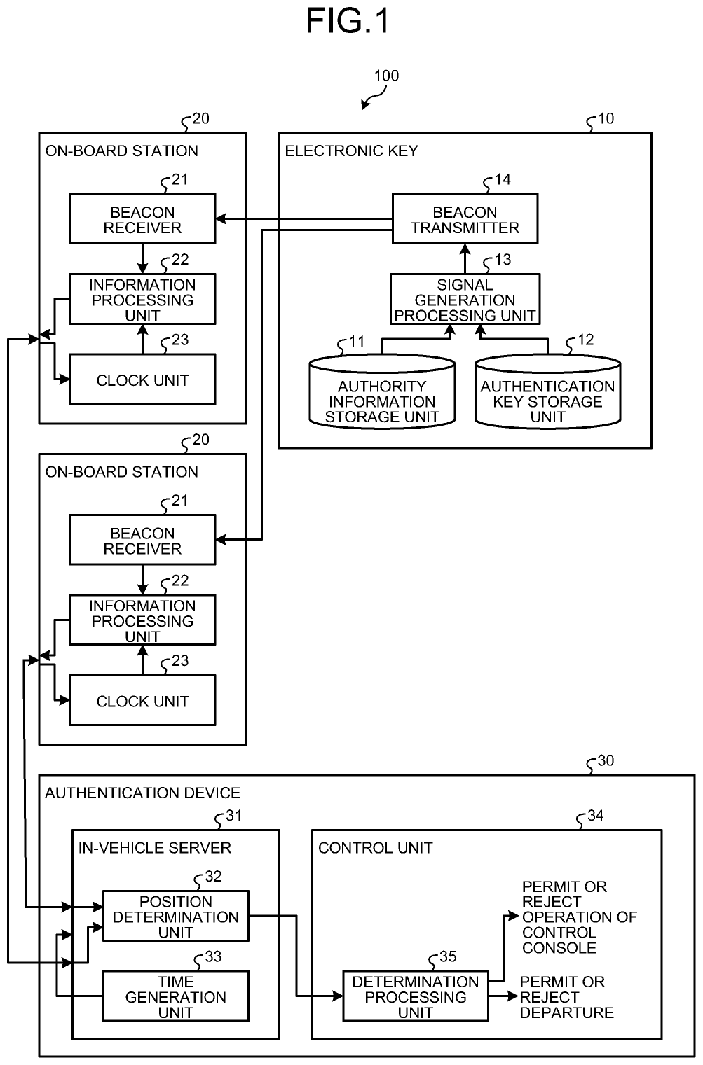

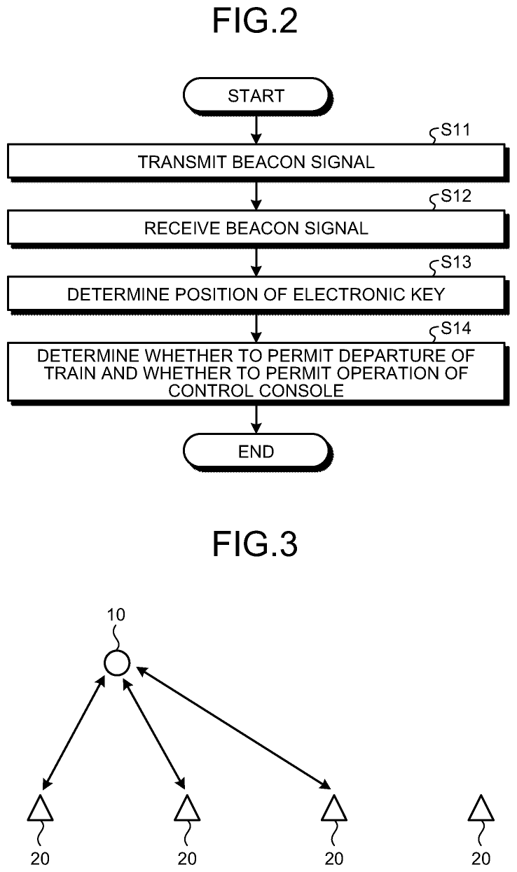

FIG. 1 is a diagram illustrating an exemplary configuration of an authentication system 100 according to the first embodiment. The authentication system 100 is a system for use in an automatically operable train. The authentication system 100 includes an electronic key 10, on-board stations 20, and an authentication device 30. In the example of FIG. 1, the authentication system 100 is shown as including two on-board stations 20 for sake of simplicity, but the authentication system 100 is expected to include a plurality of on-board stations 20. FIG. 2 is a flowchart illustrating the operation of the authentication system 100 according to the first embodiment.

The electronic key 10 transmits a beacon signal including authority information indicating authority given to the owner and an authentication key (step S11). The electronic key 10 includes an authority information storage unit 11, an authentication key storage unit 12, a signal generation processing unit 13, and a beacon transmitter 14. The authority information storage unit 11 is a storage unit that stores authority information indicating authority given to the owner of the electronic key 10. The authority information is information indicating whether the owner of the electronic key 10 is a driver who can drive the train or a crew member who cannot drive the train. The authentication key storage unit 12 is a storage unit that stores an authentication key for identifying the owner of the electronic key 10 and preventing unauthorized use. The signal generation processing unit 13 acquires the authority information from the authority information storage unit 11, acquires the authentication key from the authentication key storage unit 12, and generates a beacon signal including the authority information and the authentication key. In the following description, beacon signals may be simply referred to as signals. The beacon transmitter 14 transmits the beacon signal generated by the signal generation processing unit 13.

Note that the electronic key 10 may be a shared smartphone, tablet, or the like. In this case, face authentication, fingerprint authentication, etc. enables the electronic key 10 to rewrite the authority information stored in the authority information storage unit 11. The electronic key 10 also can acquire authority information from, for example, an operation management system that performs, for example, train operation management, and store the thus acquired authority information in the authority information storage unit 11.

The on-board stations 20, which are installed on the train, receive the beacon signal from the electronic key 10 (step S12). The on-board stations 20 each include a beacon receiver 21, an information processing unit 22, and a clock unit 23. The beacon receiver 21 receives the beacon signal transmitted from the beacon transmitter 14 of the electronic key 10. The information processing unit 22 acquires the beacon signal from the beacon transmitter 14, and acquires, from the clock unit 23, time information indicating the time of acquisition of the beacon signal from the beacon transmitter 14. The information processing unit 22 transmits the acquired beacon signal and time information to the authentication device 30. In the present embodiment, the time information indicating the time at which the information processing unit 22 acquires the beacon signal from the beacon transmitter 14 is treated as the same time as the time information indicating the time at which the on-board station 20 acquires the beacon signal. The clock unit 23 is synchronized with the time information delivered from a time generation unit 33 (described later) in the authentication device 30.

In the present embodiment, the electronic key 10 and the on-board station 20 perform communication by means of wireless technology that uses a wide frequency band extending over several hundred MHz or more, e.g. ultra wide band (UWB) although the method of wireless communication between the electronic key 10 and the on-board station 20 is not limited thereto. In addition, the authentication system 100 may be configured such that the electronic key 10 has the function of the on-board station 20 while the on-board station 20 has the function of the electronic key 10. In addition, the on-board station 20 transmits the time information indicating the time of receiving the beacon signal, and a position determination unit 32 of the authentication device 30 as will be described later uses such time information in determining the position of the electronic key 10. Alternatively, the on-board station 20 may transmit the received signal strength of the beacon signal, for example, instead of the time information. The position determination unit 32 of the authentication device 30 may use the received signal strength of the beacon signal instead of the time information, or may use both the time information and the received signal strength of the beacon signal. Note that the authentication system 100 may be configured without the clock unit 23 and the time generation unit 33 if the on-board station 20 and the authentication device 30 can perform time synchronization using another method.

The authentication device 30 determines the position of the electronic key 10 from the reception status of beacon signals including the same authentication key in a plurality of on-board stations 20 (step S13). On the basis of the position of the electronic key 10 and the authority information, the authentication device 30 determines whether to permit departure of the train and whether to permit operation of the control console of the train (step S14). The authentication device 30 includes an in-vehicle server 31 and a control unit 34. The in-vehicle server 31 includes the position determination unit 32 and the time generation unit 33. The control unit 34 includes a determination processing unit 35. Note that the present embodiment is based on the assumption that the in-vehicle server 31 and the control unit 34 in the authentication device 30 are installed on the train, but the present disclosure is not limited thereto. In the authentication device 30, the in-vehicle server 31 and/or the control unit 34 may be installed in, for example, an operation management system that performs train operation management, for example.

The position determination unit 32 determines the position of the electronic key 10 from the reception status of beacon signals including the same authentication key in a plurality of on-board stations 20. Specifically, the position determination unit 32 acquires, from a plurality of on-board stations 20, beacon signals and time information indicating the time at which each on-board stations 20 receives the beacon signal. The position determination unit 32 determines the position of the electronic key 10 from differences between the times indicated by the time information, at which times the individual on-board stations 20 receive beacon signals. FIG. 3 is a diagram illustrating an example of a method of determining the position of the electronic key 10 in the position determination unit 32 of the authentication device 30 according to the first embodiment. Assume that a beacon signal transmitted from a certain electronic key 10 has been received by three or more on-board stations 20. The position determination unit 32 acquires the time information from these three or more on-board stations 20 and can determine the position of the electronic key 10 relative to the train on the basis of the differences between the times indicated by the time information, at which times the on-board stations 20 receive beacon signals.

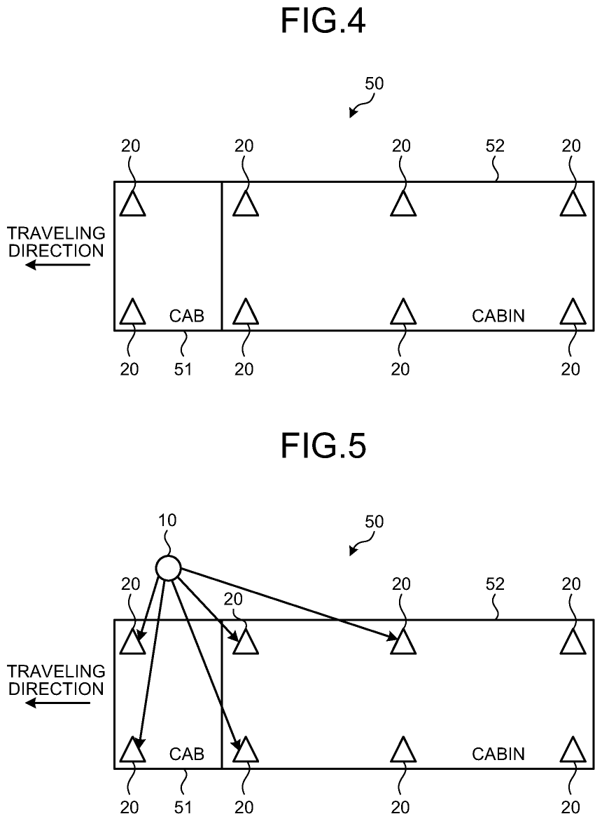

A train configuration assumed in the present embodiment will be described. FIG. 4 is a diagram illustrating an exemplary configuration of a train 50 in which the authentication system 100 according to the first embodiment is used. The train 50 is a train that can be automatically operated when set in automatic operation mode. The train 50 is made up of a cab 51 and a cabin 52. In addition, a plurality of on-board stations 20 (eight in the example of FIG. 4) are installed on the train 50. Some on-board stations 20 among the plurality of on-board stations 20 are installed in the cab 51, and the others are installed in the cabin 52. The on-board stations 20 installed in the cab 51 may be referred to as first on-board stations, and the on-board stations 20 installed in the cabin 52 may be referred to as second on-board stations. Although omitted in FIG. 4 for sake of simplicity, the train 50 may include a car made up of the cabin 52 alone, the cab 51 for use in traveling in a direction opposite to the traveling direction illustrated in FIG. 4, etc. With three or more on-board stations 20 receiving a beacon signal, the position determination unit 32 can identify the position of the electronic key 10 that has transmitted the beacon signal, and thus can determine whether the position of the electronic key 10 is in the cab 51, in the cabin 52, or outside the train 50. The position determination unit 32 outputs, to the determination processing unit 35, the determined position of the electronic key 10 and the authority information included in the beacon signal acquired from each on-board station 20.

The time generation unit 33 generates a time for use in the authentication system 100, and delivers the generated time information to each on-board station 20.

The determination processing unit 35 determines whether to permit departure of the train 50 and whether to permit operation of the control console of the train 50 on the basis of the position of the electronic key 10 and the authority information acquired from the position determination unit 32. In the present embodiment, when there is a driver or a crew member in the train 50, the determination processing unit 35 permits the departure of the train 50. When there is neither a driver nor a crew member in the train 50, the determination processing unit 35 rejects the departure of the train 50. In addition, when the driver is in the train 50 and is in the cab 51, the determination processing unit 35 permits the operation of the control console (not illustrated) in the cab 51. When the driver is in the train 50 but is in the cabin 52, the determination processing unit 35 rejects the operation of the control console. When there is a crew member alone in the train 50, the determination processing unit 35 rejects the operation of the control console regardless of the position of the crew member in the train 50. As a result, the determination processing unit 35 allows the train 50 to depart as long as the driver or crew member is in the train 50 and the driverless function of the train 50 is enabled.

Note that the authentication system 100 is provided against the authority varying between drivers and crew members, but all drivers may have different types of authority instead of having the same authority. Similarly, all crew members may have different types of authority instead of having the same authority. In this case, the authentication system 100 sets the authority for each individual, using authentication keys that identifies individuals. The position determination unit 32 outputs, to the determination processing unit 35, the determined position of the electronic key 10, the authority information included in the beacon signal acquired from each on-board station 20, and the authentication key included in the beacon signal acquired from each on-board station 20. Using the position of the electronic key 10, the authority information, and the authentication key, the determination processing unit 35 determines whether to permit the departure of the train 50 and whether to permit the operation of the control console of the train 50.

The operation of the determination processing unit 35 will be hereinafter described using specific examples. FIG. 5 is a diagram illustrating an example in which the driver is outside the train 50 in the authentication system 100 according to the first embodiment. FIG. 5 illustrates five on-board stations 20 in the authentication system 100 receiving the beacon signal transmitted from the electronic key 10 possessed by the driver. In the case of FIG. 5, the position determination unit 32 of the authentication device 30 determines that the electronic key 10 is outside the train 50. The authority information identifies the owner of the electronic key 10 as the driver, and the position determination unit 32 determines that the position of the electronic key 10 is outside the train 50. Accordingly, the determination processing unit 35 rejects the departure of the train 50 and rejects the operation of the control console in the cab 51.

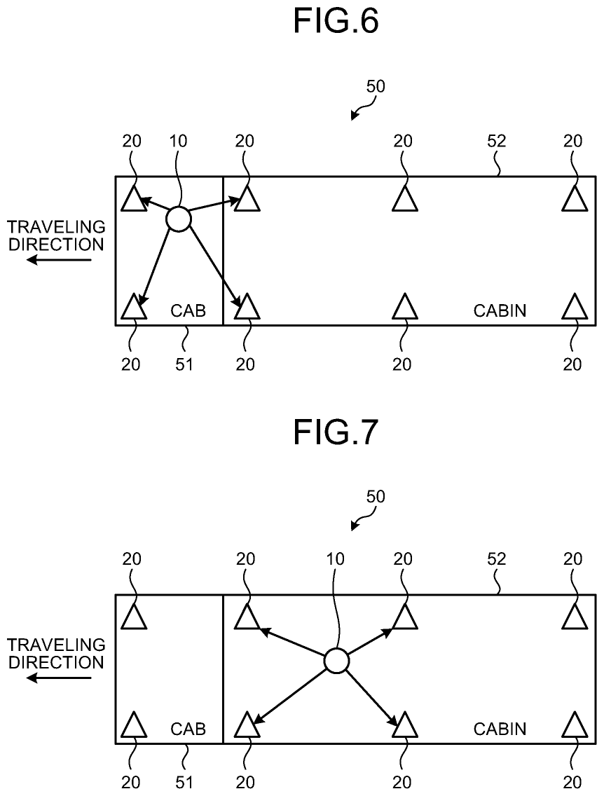

FIG. 6 is a diagram illustrating an example in which the driver is in the cab 51 of the train 50 in the authentication system 100 according to the first embodiment. FIG. 6 illustrates four on-board stations 20 in the authentication system 100 receiving the beacon signal transmitted from the electronic key 10 possessed by the driver. In the case of FIG. 6, the position determination unit 32 of the authentication device 30 determines that the electronic key 10 is in the cab 51 of the train 50. The authority information identifies the owner of the electronic key 10 as the driver, and the position determination unit 32 determines that the position of the electronic key 10 is in the cab 51 of the train 50. Accordingly, the determination processing unit 35 permits the departure of the train 50 and permits the operation of the control console in the cab 51.

FIG. 7 is a diagram illustrating an example in which the driver is in the cabin 52 of the train 50 in the authentication system 100 according to the first embodiment. FIG. 7 illustrates four on-board stations 20 in the authentication system 100 receiving the beacon signal transmitted from the electronic key 10 possessed by the driver. In the case of FIG. 7, the position determination unit 32 of the authentication device 30 determines that the electronic key 10 is in the cabin 52 of the train 50. The authority information identifies the owner of the electronic key 10 as the driver, and the position determination unit 32 determines that the position of the electronic key 10 is in the cabin 52 of the train 50. Accordingly, the determination processing unit 35 permits the departure of the train 50 and rejects the operation of the control console in the cab 51.

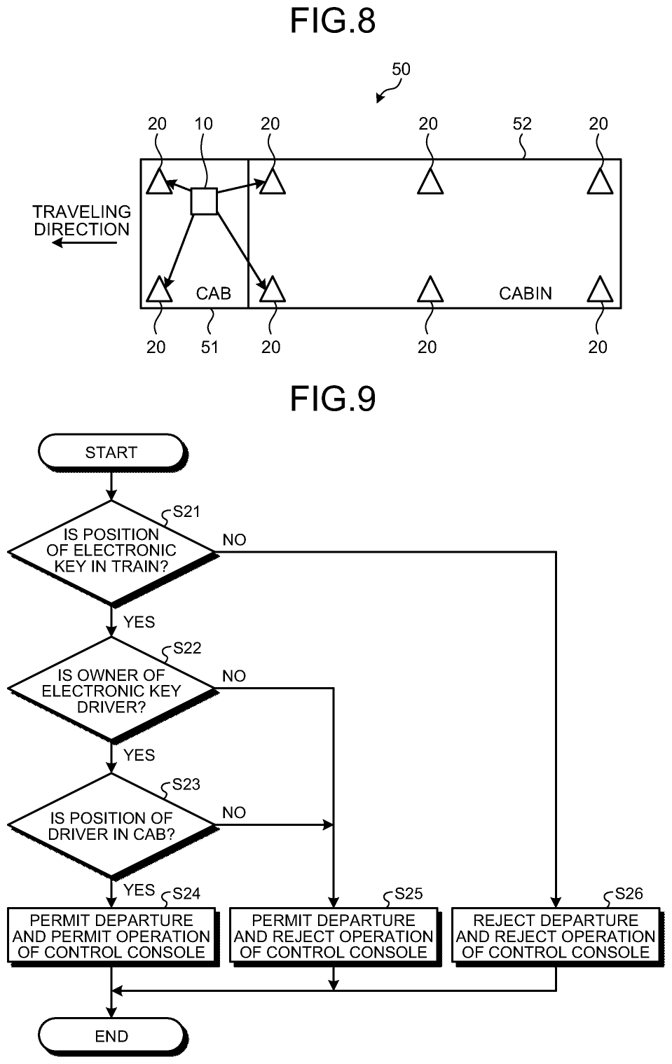

FIG. 8 is a diagram illustrating an example in which a crew member is in the cab 51 of the train 50 in the authentication system 100 according to the first embodiment. FIG. 8 illustrates four on-board stations 20 in the authentication system 100 receiving the beacon signal transmitted from the electronic key 10 possessed by the crew member. In the case of FIG. 8, the position determination unit 32 of the authentication device 30 determines that the electronic key 10 is in the cab 51 of the train 50. The authority information identifies the owner of the electronic key 10 as the crew member, and the position determination unit 32 determines that the position of the electronic key 10 is in the cab 51 of the train 50. Accordingly, the determination processing unit 35 permits the departure of the train 50 and rejects the operation of the control console in the cab 51. Note that when the crew member is in the cabin 52 not in the cab, the position determination unit 32 and the determination processing unit 35 operate as in the example of FIG. 8.

The operation of the determination processing unit 35 will be described using a flowchart. FIG. 9 is a flowchart illustrating the operation of the determination processing unit 35 of the authentication device 30 according to the first embodiment. The flowchart of FIG. 9 shows a breakdown of step S14 of the flowchart illustrated in FIG. 2.

If the position determination unit 32 determines that the position of the electronic key 10 is in the train 50 (step S21: Yes), the determination processing unit 35 determines whether the owner of the electronic key 10 is the driver, on the basis of the authority information (step S22). In response to determining that the owner of the electronic key 10 is the driver (step S22: Yes), the determination processing unit 35 determines whether the position of the electronic key 10, that is, the driver, is in the cab 51 (step S23). In response to determining that the position of the driver is in the cab 51 (step S23: Yes), the determination processing unit 35 permits the departure of the train 50 and permits the operation of the control console in the cab 51 (step S24). That is, when the position determination unit 32 determines that the position of the electronic key 10 possessed by the owner is in the cab 51, the determination processing unit 35 permits the departure of the train 50 and permits the operation of the control console in the cab 51 if the determination processing unit 35 determines that the owner is the driver on the basis of the authority information.

In response to determining that the owner of the electronic key 10 is the driver but the position of the driver is in the cabin 52 (step S23: No), the determination processing unit 35 permits the departure of the train 50 and rejects the operation of the control console in the cab 51 (step S25). That is, when the position determination unit 32 determines that the position of the electronic key 10 possessed by the owner is in the cabin 52, the determination processing unit 35 permits the departure of the train 50 and rejects the operation of the control console in the cab 51 if the determination processing unit 35 determines that the owner is the driver on the basis of the authority information.

In response to determining that the owner of the electronic key 10 is a crew member (step S22: No), the determination processing unit 35 permits the departure of the train 50 and rejects the operation of the control console in the cab 51 (step S25). That is, when the position determination unit 32 determines that the position of the electronic key 10 possessed by the owner is in the cab 51 or the cabin 52, the determination processing unit 35 permits the departure of the train 50 and rejects the operation of the control console in the cab 51 if the determination processing unit 35 determines that the owner is a crew member not qualified to drive, on the basis of the authority information.

In response to the position determination unit 32 determining that the position of the electronic key 10 is outside the train 50 (step S21: No), the determination processing unit 35 rejects the departure of the train 50 and rejects the operation of the control console in the cab 51 (step S26). That is, when the position determination unit 32 determines that the position of the electronic key 10 possessed by the owner is outside the train 50, the determination processing unit 35 rejects the departure of the train 50 and rejects the operation of the control console in the cab 51 if the determination processing unit 35 determines that the owner is the driver or a crew member not qualified to drive, on the basis of the authority information.

Note that the determination processing unit 35 may acquire work information on the driver from, for example, an operation management system that performs, for example, operation management of the train 50, and determine, for example, whether to permit the departure of the train 50. For example, in a time slot outside the working hours of the driver who possesses the electronic key 10, the determination processing unit 35 may reject the departure of the train 50 and may reject the operation of the control console in the cab 51. In addition, in the event that the driver who possesses the electronic key 10 is on any train 50 outside the scheduled travel route, the determination processing unit 35 may reject the departure of the train 50 and reject the operation of the control console in the cab 51. As a result, the authentication system 100 can avoid a situation in which the driver intentionally uses an unscheduled train 50, and avoid a situation in which the driver mistakenly gets on an unscheduled train 50.

It is also possible that the position determination unit 32 determines the positions of a plurality of electronic keys 10 from information provided by authentication keys. That is, it is possible that there are a plurality of drivers or crew members who possess the electronic keys 10 near the train 50. In response to determining from information provided by authentication keys that a plurality of on-board stations 20 has received beacon signals from a plurality of electronic keys 10, the determination processing unit 35 determines whether to permit departure of the train 50 and whether to permit operation of the control console in the cab 51, using the electronic key 10 possessed by the driver or crew member on board the train 50 as a target. In such a case, the determination processing unit 35 determines the electronic key 10 that is the target, on the basis of the work schedules of drivers and crew members and information acquired from, for example, an operation management system that performs, for example, operation management of the train 50.

Next, hardware configurations of the authentication system 100 according to the first embodiment will be described. In the authentication system 100, the electronic key 10 and the on-board station 20 are instruments capable of wireless communication. The authentication device 30 is implemented by processing circuitry. The processing circuitry may be a memory storing a program and a processor that executes a program stored in the memory, or may be dedicated hardware. The processing circuitry is also called a control circuit.

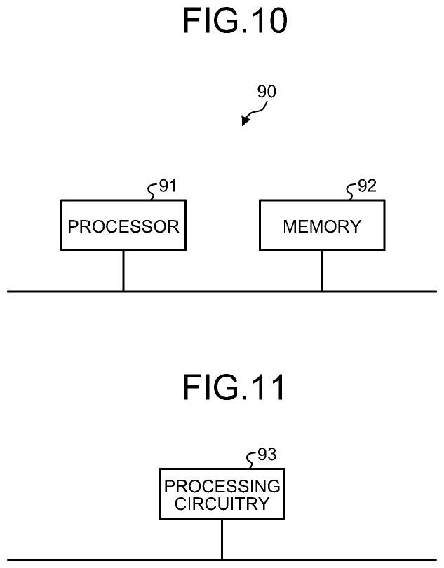

FIG. 10 is a diagram illustrating an exemplary configuration of processing circuitry 90 in the case that the processing circuitry provided in the authentication system 100 according to the first embodiment is implemented by a processor 91 and a memory 92. The processing circuitry 90 illustrated in FIG. 10 is a control circuit and includes the processor 91 and the memory 92. In a case where the processing circuitry 90 is configured with the processor 91 and the memory 92, each function of the processing circuitry 90 is implemented by software, firmware, or a combination of software and firmware. Software or firmware is described as a program and stored in the memory 92. In the processing circuitry 90, the processor 91 reads and executes the program stored in the memory 92, thereby implementing each function. That is, the processing circuitry 90 includes the memory 92 for storing a program that results in the execution of processing of the authentication system 100. It can also be said that this program is a program for causing the authentication system 100 to execute each function implemented by the processing circuitry 90. This program may be provided by a storage medium in which the program is stored, or may be provided by other means such as a communication medium.

It can also be said that the above program is a program that causes the authentication system 100 to execute: a first step in which the electronic key 10 transmits a beacon signal including authority information indicating authority given to the owner and an authentication key; a second step in which a plurality of on-board stations 20 installed on the train 50 receive the beacon signal from the electronic key 10; and a third step in which the authentication device 30 determines the position of the electronic key 10 from the reception status of beacon signals including the same authentication key in the plurality of on-board stations 20, and determines, on the basis of the position of the electronic key 10 and the authority information, whether to permit departure of the train 50 and whether to permit operation of the control console of the train 50.

The processor 91 is exemplified by a central processing unit (CPU), a processing device, an arithmetic device, a microprocessor, a microcomputer, or a digital signal processor (DSP). Examples of the memory 92 include a non-volatile or volatile semiconductor memory, a magnetic disk, a flexible disk, an optical disc, a compact disc, a mini disc, a digital versatile disc (DVD), and the like. Examples of non-volatile or volatile semiconductor memories include a random access memory (RAM), a read only memory (ROM), a flash memory, an erasable programmable ROM (EPROM), an electrically EPROM (EEPROM, registered trademark), and the like.

FIG. 11 is a diagram illustrating an exemplary configuration of processing circuitry 93 in the case that the processing circuitry provided in the authentication system 100 according to the first embodiment is implemented by dedicated hardware. For example, the processing circuitry 93 illustrated in FIG. 11 is a single circuit, a composite circuit, a programmed processor, a parallel programmed processor, an application specific integrated circuit (ASIC), a field programmable gate array (FPGA), or a combination thereof. The processing circuitry 93 may be partially implemented by dedicated hardware, and partially implemented by software or firmware. In this manner, the processing circuitry 93 can implement the above-described functions using dedicated hardware, software, firmware, or a combination thereof.

As described above, according to the present embodiment, the authentication device 30 in the authentication system 100 for use in the automatically operable train 50 can determine the position of the electronic key 10 from the reception status of beacon signals in a plurality of on-board stations 20, and determine, on the basis of the position of the electronic key 10 and the authority information of the person who possesses the electronic key 10, whether to permit departure of the train 50 and whether to permit operation of the control console of the train 50.

### Second Embodiment

In the first embodiment, the authentication system 100 determines the position of the electronic key 10 from the reception status of beacon signals including the same authentication key in a plurality of on-board stations 20. The second embodiment describes the authentication system that determines the position of the electronic key 10, by using sensors.

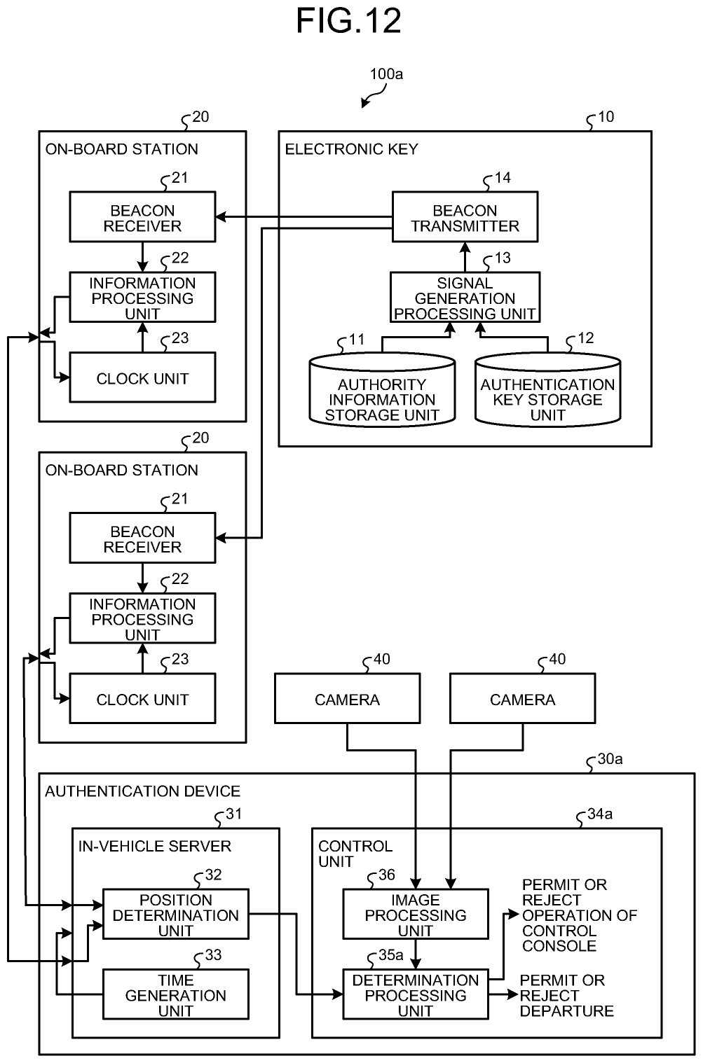

FIG. 12 is a first diagram illustrating an exemplary configuration of an authentication system 100a according to the second embodiment. The authentication system 100a is a system for use in the automatically operable train 50. The authentication system 100a is different from the authentication system 100 illustrated in FIG. 1 in deleting the authentication device 30 and adding an authentication device 30a, and cameras 40 serving as the above-described sensors. The authentication system 100a includes two cameras 40 in the example of FIG. 12, but may include three or more cameras 40. The procedure for the entire operation in the authentication system 100a is similar to the flowchart illustrated in FIG. 2 for the authentication system 100 according to the first embodiment.

The cameras 40 installed on the train 50 includes at least one camera 40 in the cab 51 and one camera 40 in the cabin 52. The cameras 40 is installable in any place, providing that the cameras can capture the entire cab 51 or the entire cabin 52. The same number of cameras 40 as the on-board stations 20 in the train 50 may be installed at the same positions as the on-board stations 20.

The authentication device 30a is different from the authentication device 30 according to the first embodiment illustrated in FIG. 1 in replacing the control unit 34 with a control unit 34a. The control unit 34a includes an image processing unit 36 and a determination processing unit 35a. The image processing unit 36 performs general image processing on images captured by the cameras 40, and outputs, to the determination processing unit 35a, image information after the image processing. At this time, the image processing unit 36 ensures that the determination processing unit 35a can determine the position of the cameras 40 with which the images represented by the image information have been captured.

The determination processing unit 35a determines whether to permit departure of the train 50 and whether to permit operation of the control console of the train 50, on the basis of the position of the electronic key 10 and the authority information acquired from the position determination unit 32 and the image information acquired from the image processing unit 36. For example, if the position of the electronic key 10 has been determined to be in the cab 51 of the train 50 but no person is found at the corresponding position in the image information acquired from the image processing unit 36, the determination processing unit 35a rejects the departure of the train 50 and rejects the operation of the control console in the cab 51. An Example where the position of the electronic key 10 has been determined to be in the cab 51 of the train 50 but no person is found at the corresponding position is where the owner of the electronic key 10 has left or dropped the electronic key 10 in the cab 51 of the train 50. As a result, as compared with the determination processing unit 35 in the first embodiment, the determination processing unit 35a can reject the departure of the train 50 in situations where the departure of the train 50 should be rejected.

In addition, the determination processing unit 35a may determine, from the image information acquired from the image processing unit 36, whether the person at the corresponding position is the driver or crew member. Generally, railroad company staff including drivers and crew members often wear uniforms. In cases where the person at the corresponding position in the image information acquired from image processing unit 36 is neither the driver nor crew member, it is likely that the true owner has the electronic key 10 stolen. In view of this, the determination processing unit 35a determines whether the person at the position of the electronic key 10 captured by the camera 40 is the driver or crew member of the train 50 or is neither the driver nor crew member, and rejects the departure of the train 50 in response to determining that the person is neither the driver nor crew member.

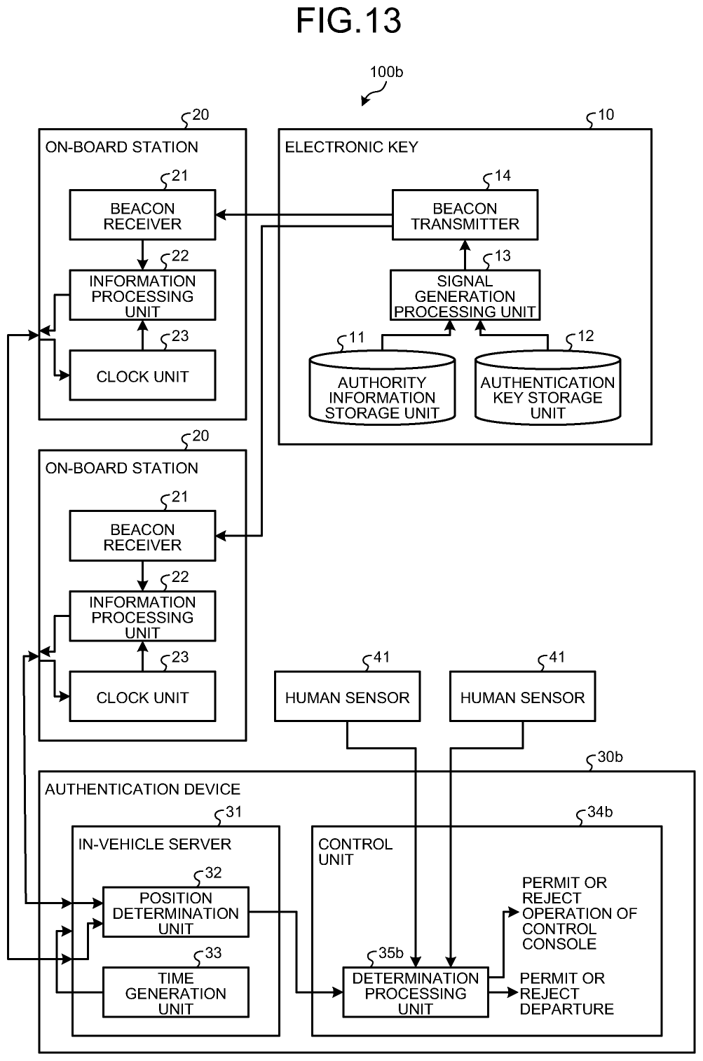

Note that the authentication system can also use sensors different from the cameras 40. FIG. 13 is a second diagram illustrating an exemplary configuration of an authentication system 100b according to the second embodiment. The authentication system 100b is a system for use in the automatically operable train 50. The authentication system 100b is different from the authentication system 100a illustrated in FIG. 12 in deleting the authentication device 30a and the cameras 40, and adding an authentication device 30b, and adding human sensors 41 as the above-described sensors. The authentication device 30b is different from the authentication device 30 according to the first embodiment illustrated in FIG. 1 in replacing the control unit 34 with a control unit 34b. The control unit 34b includes a determination processing unit 35b. The authentication system 100b includes two human sensors 41 in the example of FIG. 13, but may include three or more human sensors 41. The procedure for the entire operation in the authentication system 100b is similar to the flowchart illustrated in FIG. 2 for the authentication system 100 according to the first embodiment.

The human sensors 41 installed on the train 50 includes at least one human sensor 41 in the cab 51 and one human sensor 41 in the cabin 52. The human sensors is installable in any place, providing that the human sensors can have a detection range covering the whole cab 51 or cabin 52. The same number of human sensors 41 as the on-board stations 20 in the train 50 may be installed at the same positions as the on-board stations 20. In this manner, the authentication system 100b may include the human sensors 41 as sensors installed in the cab 51 and the cabin 52 of the train 50 and determine the presence or absence of a person in the detection range. The determination processing unit 35b determines whether to permit departure of the train 50, using detection results provided by the human sensors 41. In this case, unlike in the case of the cameras 40, the determination processing unit 35b cannot determine from the human sensors 41 installed in the authentication system 100b whether the person at the position of the electronic key 10 is the driver or crew member of the train 50 or is neither the driver nor crew member. The authentication system 100b, which is in a simpler configuration than that including the cameras 40, can provide against the owner of the electronic key 10 having left or dropped the electronic key 10 in the cab 51 of the train 50.

In addition, the authentication system 100 may use, as a sensor, a seating sensor installed in the seat of the control console in the cab 51. In this case, the determination processing unit 35 determines that the driver is present in the cab 51 upon determining from a detection result provided by the seating sensor that some person is seated on the seat of the control console. In addition, the authentication systems 100a and 100b may additionally use a seating sensor.

Regarding the hardware configuration of the authentication system 100a, the cameras 40 are digital cameras capable of outputting information of captured images. The authentication device 30a is implemented by processing circuitry. Similarly, regarding the hardware configuration of the authentication system 100b, the human sensors 41 are sensors capable of outputting information of detected images. The authentication device 30b is implemented by processing circuitry. The processing circuitry may be a memory storing a program and a processor that executes a program stored in the memory, or may be dedicated hardware.

As described above, according to the present embodiment, the authentication device 30a of the authentication system 100a uses image information obtained by the cameras 40 which are sensors, as compared with the authentication device 30 in the first embodiment. As a result, the authentication device 30a can reject the departure of the train 50 in situations where the departure of the train 50 should be rejected, such as a situation where the owner of the electronic key 10 has left or dropped the electronic key 10 in the cab 51 of the train 50. The authentication system 100b can also achieve a similar effect.

The configurations described in the above-mentioned embodiments indicate examples. The embodiments can be combined with another well-known technique and with each other, and some of the configurations can be omitted or changed in a range not departing from the gist.

### REFERENCE SIGNS LIST

10 electronic key; 11 authority information storage unit; 12 authentication key storage unit; 13 signal generation processing unit; 14 beacon transmitter; 20 on-board station; 21 beacon receiver; 22 information processing unit; 23 clock unit; 30, 30a, 30b authentication device; 31 in-vehicle server; 32 position determination unit; 33 time generation unit; 34, 34a, 34b control unit; 35, 35a, 35b determination processing unit; 36 image processing unit; 40 camera; 41 human sensor; 50 train; 51 cab; 52 cabin; 100, 100a, 100b authentication system.

1. An authentication system comprising:
an electronic key to transmit a signal including authority information indicating authority given to an owner and an authentication key;
a plurality of on-board stations installed on a train to receive the signal from the electronic key; and
authentication circuitry to determine a position of the electronic key from a reception status of the signal including the same authentication key in the plurality of on-board stations, and determine, on a basis of the position of the electronic key and the authority information, whether to permit departure of the train and whether to permit operation of a control console of the train.

2. The authentication system according to claim 1, wherein
the plurality of on-board stations includes a first on-board station installed in a cab of the train, and a second on-board station installed in a cabin of the train, and
the authentication circuitry determines whether the position of the electronic key is in the cab, in the cabin, or outside the train.

3. The authentication system according to claim 2, wherein
the authentication circuitry permits departure of the train and permits operation of the control console in the cab in response to determining that the position of the electronic key possessed by the owner is in the cab and determining that the owner is a driver on the basis of the authority information.

4. The authentication system according to claim 2, wherein
the authentication circuitry permits departure of the train and rejects operation of the control console in the cab in response to determining that the position of the electronic key possessed by the owner is in the cabin and determining that the owner is a driver on the basis of the authority information.

5. The authentication system according to claim 2, wherein
the authentication circuitry permits departure of the train and rejects operation of the control console in the cab in response to determining that the position of the electronic key possessed by the owner is in the cab or in the cabin and determining that the owner is a crew member not qualified to drive, on the basis of the authority information.

6. The authentication system according to claim 2, wherein
the authentication circuitry rejects departure of the train and rejects operation of the control console in the cab in response to determining that the position of the electronic key possessed by the owner is outside the train and determining that the owner is a driver or a crew member not qualified to drive, on the basis of the authority information.

7. The authentication system according to claim 2, wherein
in response to determining from information provided by the authentication key that the plurality of on-board stations has received the signal from a plurality of the electronic keys, the authentication circuitry determines whether to permit departure of the train and whether to permit operation of the control console, using the electronic key possessed by a driver or a crew member on board the train as a target.

8. The authentication system according to claim 7, wherein
the authentication circuitry determines the electronic key that is the target, on the basis of a work schedule of the driver and the crew member and information acquired from an operation management system that performs operation management of the train.

9. The authentication system according to claim 2, comprising
a camera installed in a cab and a cabin of the train, wherein
the authentication circuitry determines whether a person at the position of the electronic key captured by the camera is a driver or a crew member of the train or is neither the driver nor the crew member, and rejects departure of the train in response to determining that the person is neither the driver nor the crew member.

10. The authentication system according to claim 2, comprising
a human sensor installed in a cab and a cabin of the train to determine presence or absence of a person in a detection range, wherein
the authentication circuitry determines whether to permit departure of the train, using a detection result provided by the human sensor.

11. An authentication device constituting an authentication system together with: an electronic key to transmit a signal including authority information indicating authority given to an owner and an authentication key; and a plurality of on-board stations installed on a train to receive the signal from the electronic key, the authentication device comprising:
position determination circuitry to determine a position of the electronic key from a reception status of the signal including the same authentication key in the plurality of on-board stations; and
determination processing circuitry to determine, on a basis of the position of the electronic key and the authority information, whether to permit departure of the train and whether to permit operation of a control console of the train.

12. The authentication device according to claim 11, wherein
the plurality of on-board stations includes a first on-board station installed in a cab of the train, and a second on-board station installed in a cabin of the train, and
the position determination circuitry determines whether the position of the electronic key is in the cab, in the cabin, or outside the train.

13. The authentication device according to claim 12, wherein
the determination processing circuitry permits departure of the train and permits operation of the control console in the cab in response to the position determination unit determining that the position of the electronic key possessed by the owner is in the cab and determining that the owner is a driver on the basis of the authority information.

14. The authentication device according to claim 12, wherein
the determination processing circuitry permits departure of the train and rejects operation of the control console in the cab in response to the position determination unit determining that the position of the electronic key possessed by the owner is in the cabin and determining that the owner is a driver on the basis of the authority information.

15. The authentication device according to claim 12, wherein
the determination processing circuitry permits departure of the train and rejects operation of the control console in the cab in response to the position determination unit determining that the position of the electronic key possessed by the owner is in the cab or in the cabin and determining that the owner is a crew member not qualified to drive, on the basis of the authority information.

16. The authentication device according to claim 12, wherein
the determination processing circuitry rejects departure of the train and rejects operation of the control console in the cab in response to the position determination unit determining that the position of the electronic key possessed by the owner is outside the train and determining that the owner is a driver or a crew member not qualified to drive, on the basis of the authority information.

17. The authentication device according to claim 12, wherein
in response to determining from information provided by the authentication key that the plurality of on-board stations has received the signal from a plurality of the electronic keys, the determination processing circuitry determines whether to permit departure of the train and whether to permit operation of the control console, using the electronic key possessed by a driver or a crew member on board the train as a target.

18. The authentication device according to claim 17, wherein
the determination processing circuitry determines the electronic key that is the target, on the basis of a work schedule of the driver and the crew member and information acquired from an operation management system that performs operation management of the train.

19. The authentication device according to claim 12, wherein
the authentication system includes a camera installed in a cab and a cabin of the train, and
the determination processing circuitry determines whether a person at the position of the electronic key captured by the camera is a driver or a crew member of the train or is neither the driver nor the crew member, and rejects departure of the train in response to determining that the person is neither the driver nor the crew member.

20. (canceled)

21. An authentication method for an authentication system, the authentication method comprising:
transmitting a signal including authority information indicating authority given to an owner and an authentication key;
receiving the signal from the electronic key; and
determining a position of the electronic key from a reception status of the signal including the same authentication key in a plurality of on-board stations, and determining, on a basis of the position of the electronic key and the authority information, whether to permit departure of a train and whether to permit operation of a control console of the train.
